(19) United States
(12) Patent Application Publication
(10) Pub. No.: US 2016/0249164 A1
(43) Pub. Date: Aug. 25, 2016

(54) TECHNIQUES FOR USE IN DETERMINING A POSITION USING VISIBLE LIGHT COMMUNICATION

(71) Applicant: QUALCOMM Incorporated, San Diego, CA (US)

(72) Inventor: Aleksandar JOVICIC, Jersey City, NJ (US)

(21) Appl. No.: 14/631,534

(22) Filed: Feb. 25, 2015

(51) Int. Cl. H04W 4/02; H04B 10/116; H04M 1/02

(52) U.S. Cl. CPC H04W 4/023; H04M 1/0202; H04B 10/116; H04W 4/026

(57) ABSTRACT

Provided are apparatus and methods for determining a position of a mobile device. An exemplary method includes detecting first and second visible light communication (VLC) transmissions from respective first and second. VLC light fixtures having a known fixture vector between the first and second. VLC light fixtures. The exemplary method includes determining a first device vector and a second device vector between the mobile device and the respective first and second VLC light fixtures. The exemplary method includes creating a compensated fixture vector by converting the fixture vector to the mobile device coordinate system. The exemplary method includes calculating a first and second distance between the mobile device and the respective first and second VLC light fixtures, as well as using the first distance and the second distance to triangulate the position of the mobile device relative to the first and second VLC light fixtures.

### INTRODUCTION

This disclosure relates generally to electronics, and more specifically, but not exclusively, to methods, apparatuses, and articles of manufacture that determine a position of a device and/or otherwise make use of a visible light communication (VLC) transmission.

Information communicated by a specific LED luminary device using VLC can include an identifier that identifies the specific LED luminary device from another LED luminary device. However, groups of LED luminary devices often are not programmed with unique identifiers. This non-uniqueness can cause gross positioning ambiguity when a mobile device attempts to locate the mobile device's position using transmissions from the non-unique LED luminary devices.

Accordingly, there are long-felt industry needs for methods and apparatus that improve upon conventional methods and apparatus, including the provided improved methods and improved apparatus.

### SUMMARY

This summary provides a basic understanding of some exemplary aspects of the present teachings. This summary is not exhaustive in detail, and is neither intended to identify all critical features, nor intended to limit the scope of the claims.

Exemplary methods and apparatus for determining a position of a mobile device are provided. An exemplary method includes: detecting a first visible light communication (VLC) transmission from a first VLC light fixture; detecting a second VLC transmission from a second VLC light fixture, where a fixture vector between the first VLC light fixture and the second VLC light fixture is known; determining, using the detected first VLC transmission, a first device vector between the mobile device and the first VLC light fixture; determining, using the detected second VLC transmission, a second device vector between the mobile device and the second VLC light fixture; measuring, using a tilt sensor, a rotation matrix of a mobile device coordinate system relative to an absolute coordinate system; creating a compensated fixture vector by converting, using the rotation matrix, the fixture vector to the mobile device coordinate system; calculating a first distance between the mobile device and the first VLC light fixture, and a second distance between the mobile device and the second VLC light fixture, from the compensated fixture vector, the first device vector, and the second device vector; and triangulating the position of the mobile device relative to the first VLC light fixture and the second VLC light fixture using the first distance and the second distance. The method can further include refining the position of the mobile device by combining the position of the mobile device with additional positioning data from at least one of the following: a pose estimation based on an acquired image, a radio frequency (RF) transmission, or a combination thereof. The method can further include disambiguating the position of the mobile device using a particle belief propagation filter to compute a maximum-a-posteriori (MAP) estimate from the position of the mobile device and the additional positioning data. The RF transmission can be at least one of a Bluetooth device transmission, a WiFi device transmission, an RFID device transmission, a femtocell device transmission, a Zigbee device transmission, or a combination thereof. The absolute coordinate system can be based on at least one of an absolute gravity vector, a building envelope, a geomagnetic orientation, or a combination thereof. The method can further include: detecting a third visible VLC transmission from the first VLC light fixture; detecting a fourth VLC transmission from the second VLC light fixture; determining, using the detected third VLC transmission, a third device vector between the mobile device and the first VLC light fixture; determining, using the detected second VLC transmission, a fourth device vector between the mobile device and the second VLC light fixture; calculating a third distance between the mobile device and the first VLC light fixture, and a fourth distance between the mobile device and the second VLC light fixture, from the compensated fixture vector, the third device vector, and the fourth device vector; triangulating a second position of the mobile device relative to the first VLC light fixture and the second VLC light fixture using the third distance and the fourth distance; and determining a direction of travel vector of the mobile device from the first position and the second position. The method can further include disambiguating the position of the mobile device by computing a maximum of a product of a WiFi position density and a direction of travel vector density of the direction of travel vector of the mobile device. In a further example, provided is a non-transitory computer-readable medium, having processor-executable instructions stored thereon that are executable by a processor to cause the processor to execute at least a part of the aforementioned method. The non-transitory computer-readable medium can be integrated with a device, such as a mobile device, a music player, a video player, an entertainment device, a navigation device, a communications device, a computer, or a combination thereof.

In another example, provided is an apparatus configured to determine a position of a mobile device. The apparatus includes: means for detecting a first visible light communication (VLC) transmission from a first VLC light fixture; means for detecting a second VLC transmission from a second VLC light fixture, where a fixture vector between the first VLC light fixture and the second VLC light fixture is known; means for determining, using the detected first VLC transmission, a first device vector between the mobile device and the first VLC light fixture; means for determining, using the detected second VLC transmission, a second device vector between the mobile device and the second VLC light fixture; means for measuring, using a tilt sensor, a rotation matrix of a mobile device coordinate system relative to an absolute coordinate system; means for creating a compensated fixture vector by converting, using the rotation matrix, the fixture vector to the mobile device coordinate system; means for calculating a first distance between the mobile device and the first VLC light fixture, and a second distance between the mobile device and the second VLC light fixture, from the compensated fixture vector, the first device vector, and the second device vector; and means for triangulating the position of the mobile device relative to the first VLC light fixture and the second VLC light fixture using the first distance and the second distance. The apparatus can further include means for refining the position of the mobile device by combining the position of the mobile device with additional positioning data from at least one of the following: a pose estimation based on an acquired image, a radio frequency (RF) transmission, or a combination thereof. The apparatus can further include means for disambiguating the position of the mobile device using a particle belief propagation filter to compute a maximum-a-posteriori (MAP) estimate from the position of the mobile device and the additional positioning data. The RF transmission can be at least one of a Bluetooth device transmission, a WiFi device transmission, an RFID device transmission, a femtocell device transmission, a Zigbee device transmission, or a combination thereof. The absolute coordinate system can be based on at least one of an absolute gravity vector, a building envelope, a geomagnetic orientation, or a combination thereof. The apparatus can further include: means for detecting a third visible VLC transmission from the first VLC light fixture; means for detecting a fourth VLC transmission from the second VLC light fixture; means for determining, using the detected third VLC transmission, a third device vector between the mobile device and the first VLC light fixture; means for determining, using the detected second VLC transmission, a fourth device vector between the mobile device and the second VLC light fixture; means for calculating a third distance between the mobile device and the first VLC light fixture, and a fourth distance between the mobile device and the second VLC light fixture, from the compensated fixture vector, the third device vector, and the fourth device vector; means for triangulating a second position of the mobile device relative to the first VLC light fixture and the second VLC light fixture using the third distance and the fourth distance; and means for determining a direction of travel vector of the mobile device from the first position and the second position. The apparatus can further include means for disambiguating the position of the mobile device by computing a maximum of a product of a WiFi position density and a direction of travel vector density of the direction of travel vector of the mobile device. The apparatus can be a part of the mobile device. At least a part of the apparatus can be integrated on a semiconductor die. Further, at least a part of the apparatus can include a device, such as a mobile device, a music player, a video player, an entertainment device, a navigation device, a communications device, a computer, or a combination thereof, with a part of the apparatus being a constituent part of the device. In a further example, provided is a non-transitory computer-readable medium having lithographic device-executable instructions stored thereon that are executable by a lithographic device to cause the lithographic device to fabricate at least a part of the apparatus.

In another example, provided is an apparatus. The apparatus includes a communication device and a processor coupled to the communication device. The processor is configured to: initiate detecting a first visible light communication (VLC) transmission from a first VLC light fixture; initiate detecting a second VLC transmission from a second VLC light fixture, where a fixture vector between the first VLC light fixture and the second VLC light fixture is known; initiate determining, using the detected first VLC transmission, a first device vector between the mobile device and the first VLC light fixture; initiate determining, using the detected second VLC transmission, a second device vector between the mobile device and the second VLC light fixture; initiate measuring, using a tilt sensor, a rotation matrix of a mobile device coordinate system relative to an absolute coordinate system; initiate creating a compensated fixture vector by converting, using the rotation matrix, the fixture vector to the mobile device coordinate system; initiate calculating a first distance between the mobile device and the first VLC light fixture, and a second distance between the mobile device and the second VLC light fixture, from the compensated fixture vector, the first device vector, and the second device vector; and initiate triangulating a position of the mobile device relative to the first VLC light fixture and the second VLC light fixture using the first distance and the second distance. The processor can be further configured to refine the position of the mobile device by combining the position of the mobile device with additional positioning data from at least one of a pose estimation based on an acquired image, a radio frequency (RF) transmission, or a combination thereof. The processor can be further configured to disambiguate the position of the mobile device using a particle belief propagation filter to compute a maximum-a-posteriori (MAP) estimate from the position of the mobile device and the additional positioning data. The RF transmission can be at least one of a Bluetooth device transmission, a WiFi device transmission, an RFID device transmission, a femtocell device transmission, a Zigbee device transmission, or a combination thereof. The absolute coordinate system can be based on at least one of an absolute gravity vector, a building envelope, a geomagnetic orientation, or a combination thereof. The processor can be further configured to: detect a third visible VLC transmission from the first VLC light fixture; detect a fourth VLC transmission from the second VLC light fixture; determine, using the detected third VLC transmission, a third device vector between the mobile device and the first VLC light fixture; determine, using the detected second VLC transmission, a fourth device vector between the mobile device and the second VLC light fixture; calculate a third distance between the mobile device and the first VLC light fixture, and a fourth distance between the mobile device and the second VLC light fixture, from the compensated fixture vector, the third device vector, and the fourth device vector; triangulate a second position of the mobile device relative to the first VLC light fixture and the second VLC light fixture using the third distance and the fourth distance; and determine a direction of travel vector of the mobile device from the first position and the second position. The processor can be further configured to disambiguate the position of the mobile device by computing a maximum of a product of a WiFi position density and a direction of travel vector density of the direction of travel vector of the mobile device. At least a part of the apparatus can be integrated on a semiconductor die. Further, at least a part of the apparatus can include a device, such as a mobile device, a music player, a video player, an entertainment device, a navigation device, a communications device, a computer, or a combination thereof, with a part of the apparatus being a constituent part of the device. In a further example, provided is a non-transitory computer-readable medium having lithographic-device executable instructions that are executable by a lithographic device to cause the lithographic device to fabricate at least a part of the apparatus.

The foregoing broadly outlines some of the features and technical advantages of the present teachings in order that the detailed description and drawings can be better understood. Additional features and advantages are also described in the detailed description. The conception and disclosed examples can be readily utilized as a basis for modifying or designing other structures for carrying out the same purposes of the present teachings. Such equivalent constructions do not depart from the technology of the teachings as set forth in the claims. The inventive features that are characteristic of the teachings, together with further objects and advantages, are better understood from the detailed description and the accompanying figures. Each of the figures is provided for the purpose of illustration and description only, and does not limit the present teachings.

### BRIEF DESCRIPTION OF THE DRAWINGS

The accompanying drawings are presented to aid in the description of various aspects of the disclosure and are provided solely for illustration of the aspects and not limitation thereof.

FIG. 1 depicts an exemplary communication network, in accordance with certain example implementations.

FIG. 2 depicts an exemplary functional block diagram of an exemplary mobile device, in accordance with certain example implementations.

FIG. 3 depicts an exemplary visible light communication access point, in accordance with certain example implementations.

FIG. 4 depicts an exemplary radio-frequency wireless access point, in accordance with certain example implementations.

FIGS. 5A-5D depict an exemplary method for determining a position of a mobile device, in accordance with certain example implementations.

FIG. 6 depicts a graphical example that provides further detail about the method of FIGS. 5A-5D, in accordance with certain example implementations.

FIG. 7 depicts further detail about refining and disambiguating a position of a mobile device by using a received radio-frequency transmission, in accordance with certain example implementations.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

### Introduction

At least one of the exemplary apparatuses and/or exemplary methods disclosed herein advantageously addresses the long-felt industry needs, as well as other previously unidentified needs, and mitigates shortcomings of the conventional methods and the conventional apparatus. For example, an advantage provided by at least one example of the disclosed apparatuses and/or at least one example of the methods disclosed herein is an improvement in accuracy of determining a mobile device's position over conventional devices.

More specific aspects of the disclosure are provided in this description and related drawings directed to various examples provided for illustration purposes. Alternate aspects can be devised without departing from the scope of the disclosure. Additionally, well-known aspects of the disclosure may not be described in detail or may be omitted so as not to obscure more relevant details.

As used herein, the term “exemplary” means “serving as an example, instance, or illustration.” Any example described as “exemplary” is not necessarily to be construed as preferred or advantageous over other examples. Likewise, the term “examples” does not require that all examples include the discussed feature, advantage, or mode of operation. Use of the terms “in one example,” “an example,” “in one feature,” and/or “a feature” in this specification does not necessarily refer to the same feature and/or example. Furthermore, a particular feature and/or structure can be combined with one or more other features and/or structures. Moreover, at least a portion of the apparatus described hereby can be configured to perform at least a portion of a method described hereby.

A reference using a designation such as “first,” “second,” and so forth does not limit either the quantity or the order of those elements. Rather, these designations are used as a convenient method of distinguishing between two or more elements or instances of an element. Thus, a reference to first and second elements does not mean that only two elements can be employed, or that the first element must necessarily precede the second element. Also, unless stated otherwise, a set of elements can comprise one or more elements. In addition, terminology of the form “at least one of: A, B, or C” or “one or more of A, B, or C” or “at least one of the group consisting of A, B, and C” used in the description or the claims can be interpreted as “A or B or C or any combination of these elements.” For example, this terminology can include A, or B, or C, or A and B, or A and C, or A and B and C, or 2A, or 2B, or 2C, and so on.

The terminology used herein is for the purpose of describing particular examples only and is not intended to be limiting. As used herein, the singular forms “a,” “an,” and “the” include the plural forms as well, unless the context clearly indicates otherwise. Further, the terms “comprises,” “comprising,” “includes,” and “including,” specify a presence of a feature, an integer, a step, an operation, an element, a component, and the like, but do not necessarily preclude a presence or an addition of another feature, integer, step, operation, element, component, and the like.

The term “signal” can include any signal such as a data signal, an audio signal, a video signal, a multimedia signal, an analog signal, a digital signal, and the like. Information and signals described herein can be represented using any of a variety of different technologies and techniques. For example, data, instructions, commands, information, signals, bits, symbols, and chips that are referenced herein can be represented by voltages, currents, electromagnetic waves, magnetic fields or particles, optical fields or particles, or any practical combination thereof, depending in part on the particular application, in part on a desired design, in part on a corresponding technology, and the like.

Further, some examples are described in terms of sequences of actions to be performed by, for example, elements of a computing device. The actions described herein can be performed by specific circuits (e.g., an Application Specific Integrated Circuits (ASICs)), by program instructions being executed by one or more processors (e.g., one of more special-purpose processors), or by a combination thereof. Further, for any of the examples described herein, a corresponding form of any such example can be implemented as, for example, “logic configured to” perform the described action.

It should be noted that the terms “connected,” “coupled,” and any variant thereof, mean any connection or coupling between elements, either direct or indirect, and can encompass a presence of an intermediate element between two elements that are “connected” or “coupled” together via the intermediate element. Coupling and connection between the elements can be physical, logical, or a combination thereof. Elements can be “connected” or “coupled” together, for example, by using one or more wires, cables, printed electrical connections, electromagnetic energy, and the like. The electromagnetic energy can have a wavelength at a radio frequency, a microwave frequency, a visible optical frequency, an invisible optical frequency, and the like, as practicable. These are several non-limiting and non-exhaustive examples.

In at least one example, the provided apparatuses can be a part of, and/or coupled to, an electronic device such as, but not limited to, at least one of a mobile device, a navigation device (e.g., a global positioning system receiver), a wireless device a camera, an audio player, a camcorder, and a game console.

The term “mobile device” can describe, and is not limited to, at least one of a mobile phone, a mobile communication device, a pager, a personal digital assistant, a personal information manager, a personal data assistant, a mobile hand-held computer, a portable computer, a tablet computer, a wireless device, a wireless modem, other types of portable electronic devices typically carried by a person and having communication capabilities (e.g., wireless, cellular, infrared, short-range radio, etc.), or any other device that is capable of receiving wireless communication signals used in determining a position fix. Further, the terms “user equipment” (UE), “mobile terminal,” “user device,” “mobile device,” and “wireless device” can be interchangeable.

### Abbreviations

The following list of abbreviations, acronyms, and terms is provided to assist in comprehending the current disclosure, and are not provided as limitations.
AP—Access point
DoA—Direction of Arrival
IEEE—Institute of Electrical and Electronics Engineers. A standards body responsible for developing computing and electronics standards. The IEEE developed the 802.11 group of standards for WLANs (wireless local area networks)
LAN—Local Area Network
LED—Light emitting diode
MAC—Media access control
PIP—Precise indoor positioning
RF—Radio frequency
UE—User Equipment
VLC—Visible light communication
WiFi—Short for “Wireless Fidelity.” A type of WLAN (wireless local area network). WiFi enables a mobile device user to couple the mobile device to a local area network (LAN) through a wireless connection. WiFi devices can conform to at least one IEEE 802.11 standard
WLAN—Wireless Local Area Network. Allows a mobile user to connect to a local area network (LAN) through a wireless connection

### DESCRIPTION OF THE FIGURES

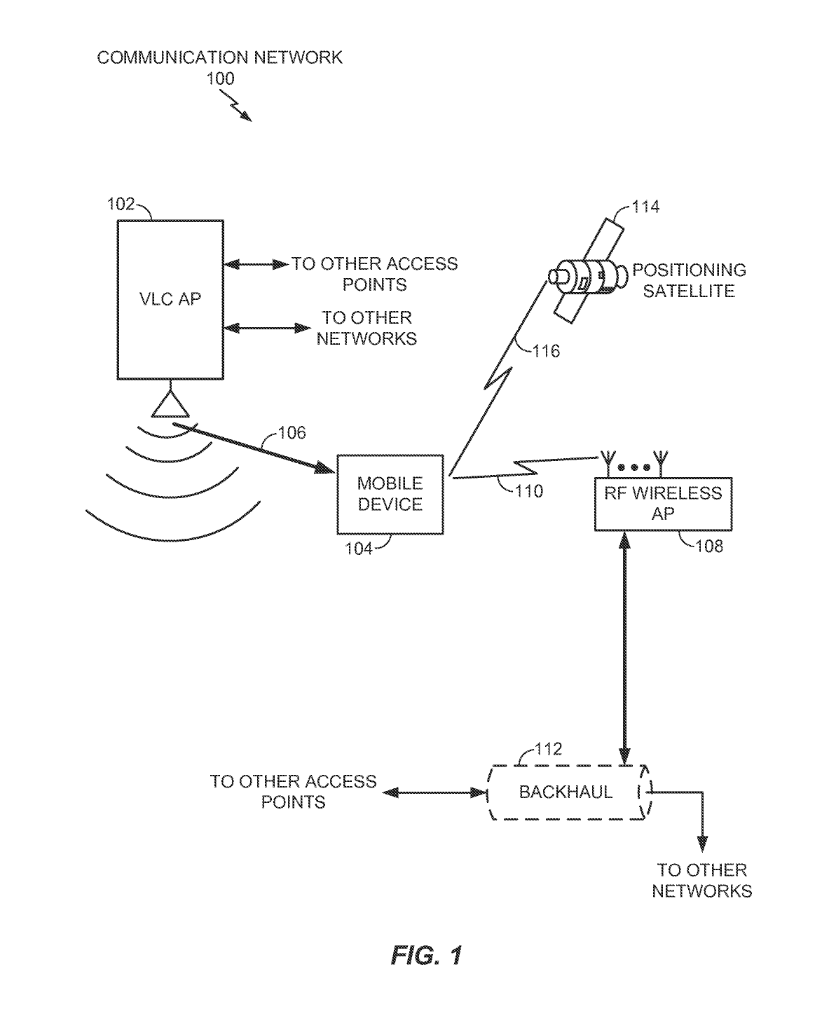

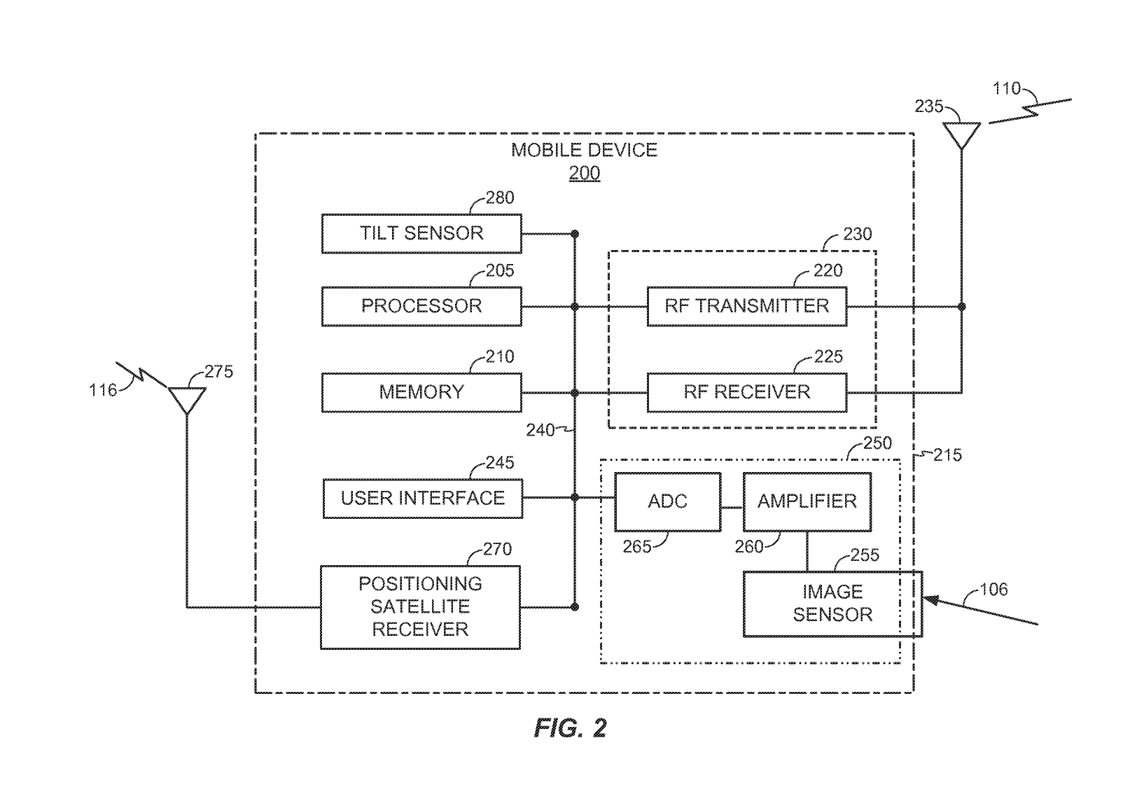

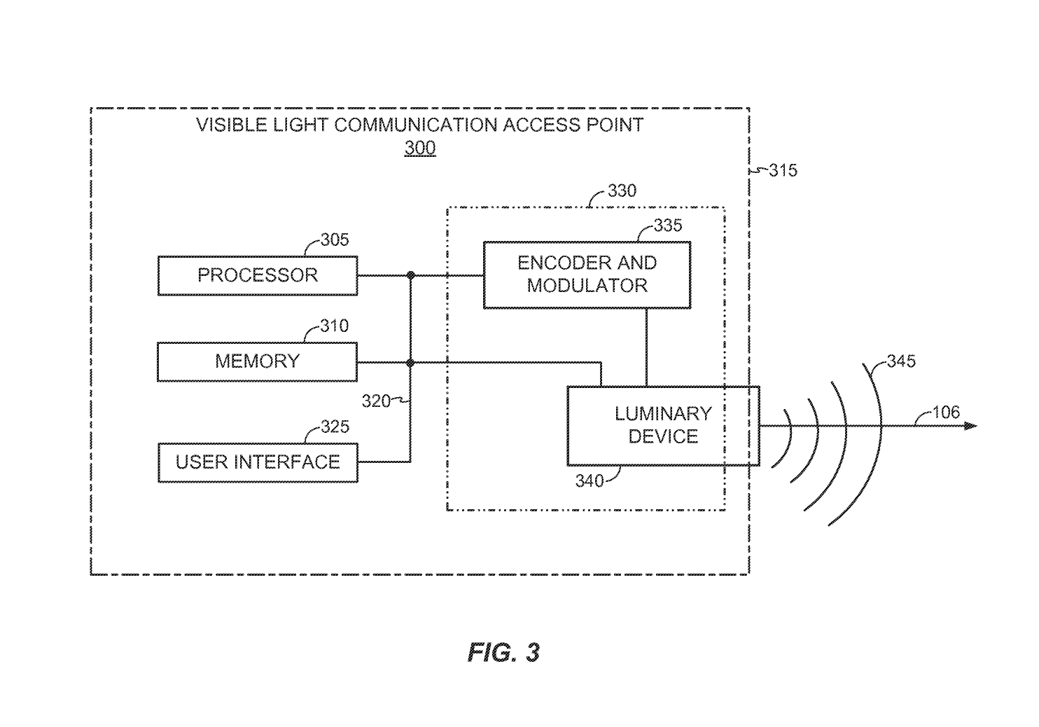

FIG. 1 depicts an exemplary communication network 100. The communication network 100 is configured to support multiple access communication between multiple users. One or more visible light communication (VLC) access points (AP) 102 provide communication coverage in the exemplary communication network 100 by interacting with one or more mobile devices 104 using a beam of visible light 106. The VLC AP 102 can provide access to and/or from other APs (e.g., another VLC AP) and/or other networks (e.g., the Internet). The VLC AP 102 is described in greater detail in FIG. 3, and the mobile devices 104 is described in greater detail in FIG. 2.

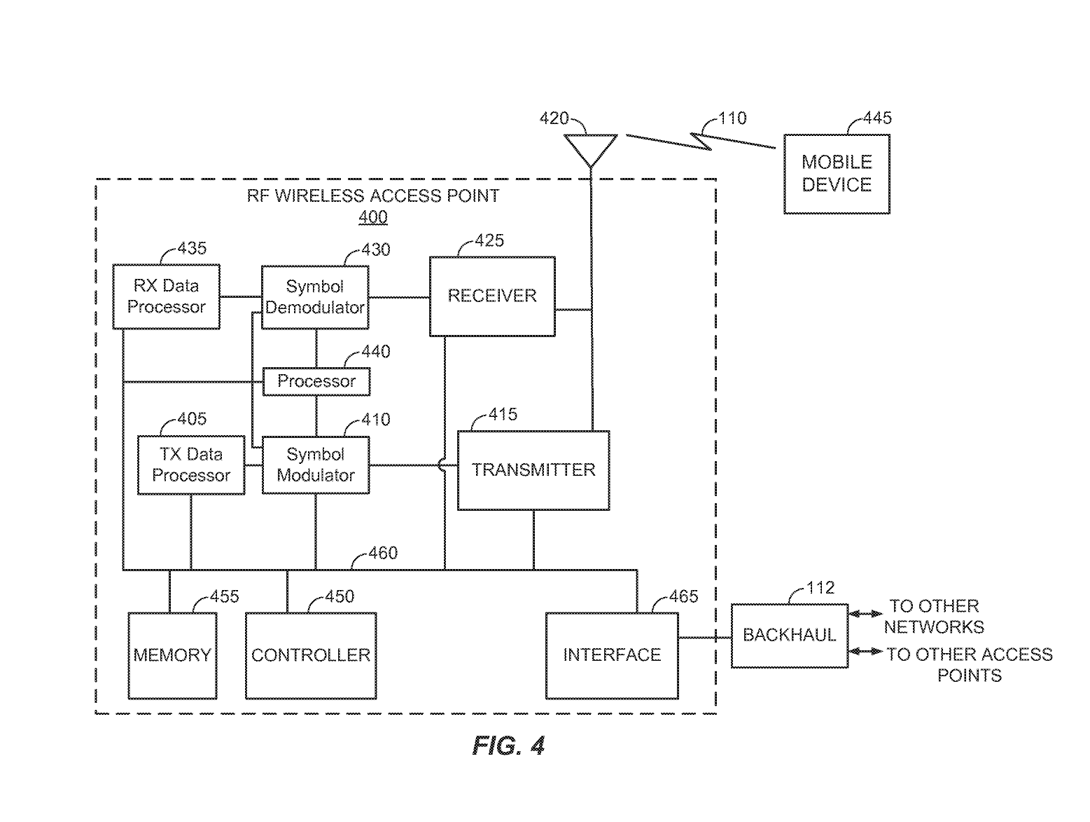

The communication network 100 can also include one or more radio frequency wireless APs 108 that can interact with one or more mobile devices 104 using a radio-frequency (RF) transmission 110. The radio frequency wireless AP 108 is described in greater detail in FIG. 4. For simplicity, one radio frequency wireless AP 108 is depicted in FIG. 1. The radio frequency wireless AP 108 can provide coordination and control among multiple mobile devices, such as the mobile device 104, as well as access to and/or from other APs and/or other networks (e.g., at least one of the Internet, a cellular network, a private network, and the like) via a backhaul connection 112. The communication network 100 can also include one or more positioning satellites 114 that can interact with one or more mobile devices 104 using a satellite RF transmission 116. The positioning satellite 114 can be a satellite such as those found in the global positioning system (GPS), the global navigation satellite system (GLONASS), and the like.

The communication network 100 can be referred to as a wireless local area network (WLAN), and can employ one or more of a variety of networking protocols to couple devices. Some of these networking protocols can be referred to as “WiFi,” including any member of the Institute of Electrical and Electronics Engineers (IEEE) 802.11 wireless protocol family.

FIG. 2 depicts an exemplary functional block diagram of an exemplary mobile device 200, which can correspond to the mobile device 104. FIG. 2 also depicts different components that can a part of the mobile device 200. The mobile device 200 is an example of a device that can be configured to include at least a portion of the apparatus described herein. Further, the mobile device 200 is an example of a device that can be configured to perform at least a part of a method described herein.

The mobile device 200 can include a processor 205 which is configured to control operation of the mobile device 200, and can perform at least a part of a method described herein. The processor 205 can be configured to determine a respective location of the mobile device 200. The processor 205 can determine two-dimensional coordinates, three-dimensional coordinates, latitudes and longitudes, Cartesian coordinates, spherical coordinates, geodesic coordinates, and/or other suitable location indicators associated with the mobile device 200, a visible light communication (VLC) access point (AP) 300, and/or a radio frequency wireless AP 400.

The processor 205 can be a central processing unit (CPU) and/or a special-purpose processor. A memory 210, which can include at least one of read-only memory (ROM) and random access memory (RAM) provides at least one of instructions and data to the processor 205. The data can include a location of VLC APs. The processor 205 can perform logical and arithmetic operations based on processor-executable instructions stored within the memory 210. The instructions stored in the memory 210 can be executed to implement at least a part of a method described herein.

The processor 205 can comprise or be a component of a processing system implemented with one or more processors. The one or more processors can be implemented with a microprocessor, a microcontroller, a digital signal processor (DSP), a field programmable gate array (FPGA), a programmable logic device (PLD), an application-specific integrated circuit (ASIC), a controller, a non-generic computer, a state machine, gated logic, at least one discrete hardware component, a dedicated hardware finite state machine, any other suitable entity that can at least one of manipulate information (e.g., calculating, logical operations, and the like) and control another device, or a combination thereof. The processing system can also include a non-transitory machine-readable media (e.g., the memory 210) that stores software. Software can mean any type of instructions, whether referred to as at least one of software, firmware, middleware, microcode, hardware description language, and the like. Instructions can include code (e.g., in source code format, binary code format, executable code format, or any other suitable code format). The instructions, when executed by the processor 205, can transform the processor 205 into a special-purpose processor that is configured to perform at least a part of a function described herein.

The mobile device 200 can also include a housing 215, an RF transmitter 220, and an RF receiver 225 to allow transmission and reception of data between the mobile device 200 and a remote location. The RF transmitter 220 and the RF receiver 225 can be combined into a transceiver 230. An RF antenna 235 can be attached to the housing 215 and electrically coupled to the transceiver 230. The RF transmitter 220 can be configured to send the RF transmission 110 via the RF antenna 235 and/or the RF receiver 225 can be configured to receive the RF transmission 110 via the RF antenna 235. The mobile device 200 can also include (not shown in FIG. 2) multiple transmitters, multiple receivers, multiple transceivers, and/or multiple antennas.

The components of the mobile device 200 can be coupled together by a bus system 240. The bus system 240 can include at least one of a data bus, a power bus, a control signal bus, and a status signal bus. The components of the mobile device 200 can be coupled together to accept and/or provide inputs to each other using a different suitable mechanism.

The mobile device 200 can also further comprise a user interface 245. The user interface 245 can comprise at least one of a keypad, a touchscreen, a microphone, a speaker, or a display. The user interface 245 can include a component that at least one of conveys information to a user of the mobile device 200 and receives input from the user.

The mobile device 200 can further comprise a VLC receiver 250 that is configured to communicate with a VLC AP, such as the VLC AP 102. The VLC receiver 250 can include an image sensor 255 (e.g., a photodiode, a camera, a CMOS sensor, and the like), an amplifier 260, and an analog to digital converter (ADC) 265. Visible light transmissions (e.g., the beam of visible light 106 from the VLC AP 102) detected by the image sensor 255 are amplified by the amplifier 260, and the amplified analog signal is processed by the ADC 265 resulting in a digital signal communicating information which is received and processed by the processor 205.

The processor 205 can decode a VLC identifier embedded in visible light transmissions to identify one or more VLC APs. Ideally, each VLC AP has a unique identifier, however, in practice, this may not be the situation, and multiple VLC APs may be transmitting the same identifier. The processor 205 can also process data received via the visible light transmissions. The data can include a venue ID, information specific to the venue (e.g., advertising, a message targeting a user of the mobile device), a location of the VLC AP relative to an absolute coordinate system, and the like.

The mobile device 200 can further comprise a positioning satellite receiver 270 that is configured to communicate with a positioning satellite, such as the positioning satellite 114, via a positioning satellite antenna 275.

The mobile device 200 can further comprise a tilt sensor 280 that is configured to measure, a rotation matrix of a mobile device coordinate system relative to the absolute coordinate system. The absolute coordinate system can be based on at least one of an absolute gravity vector, a building envelope, a geomagnetic orientation, or a combination thereof.

FIG. 3 depicts the exemplary visible light communication (VLC) access point (AP) 300. The VLC AP 300 can correspond to the VLC AP 102. The VLC AP 300 is capable of receiving and/or transmitting using visible light. Visible light communication is a method of communicating by modulating intensity of a visible light emitted by a luminary device, such as a light emitting diode (LED). Visible light is light having a wavelength in a range of 380 to 780 nm—which is visible to a human eye. Since humans cannot perceive on-off cycles of the luminary device above a certain number of cycles per second (e.g., 150 Hz), the transmission input to the luminary device can modulated (e.g., using Pulse Width Modulation (PWM), amplitude modulation (AM)) in order to communicate information using VLC, without appearing to a human observer to have annoying flicker.

The communication network 100 can support any practicable number of the VLC AP 300 distributed in a geographic region (also known as a venue) to provide communication coverage for at least one mobile device. Exemplary venues include a shopping mall wing, a store in a shopping mall, a terminal in an airport, a department in a store, a classroom in a school building, a floor in a structure (e.g., a building, a home), a hall in a structure, and the like. For simplicity, only one VLC AP is depicted in FIG. 3. The VLC AP 300 can be a fixed entity. However, the VLC AP 300 can be mobile in some implementations (e.g., a mobile device serving as a VLC AP 300 for other devices).

FIG. 3 also depicts different components that can a part of the VLC AP 300. The VLC AP 300 is an example of a device that can be configured to include at least a portion of the apparatus described herein. Further, the VLC AP 300 is an example of a device that can be configured to perform at least a part of a method described herein.

As depicted in FIG. 3, the VLC AP 300 can include a processor 305 which is configured to control operation of the VLC AP 300, and can perform at least a part of a method described herein. The processor 305 can be configured to assist in determining a respective location of the mobile device 200 and/or the VLC AP 300. The processor 305 can determine two-dimensional coordinates, three-dimensional coordinates, latitudes and longitudes, Cartesian coordinates, spherical coordinates, geodesic coordinates, and/or other suitable location indicators associated with the mobile device 200, the VLC AP 300, and/or the RF wireless AP 400.

The processor 305 can be a central processing unit (CPU) and/or a special-purpose processor. A memory 310, which can include at least one of read-only memory (ROM) and random access memory (RAM) provides at least one of instructions and data to the processor 305. The processor 305 can perform logical and arithmetic operations based on processor-executable instructions stored within the memory 310. The instructions stored in the memory 310 can be executed to implement at least a part of a method described herein.

The processor 305 can comprise or be a component of a processing system implemented with one or more processors. The one or more processors can be implemented with a microprocessor, a microcontroller, a digital signal processor (DSP), a field programmable gate array (FPGA), a programmable logic device (PLD), an application-specific integrated circuit (ASIC), a controller, a non-generic computer, a state machine, gated logic, at least one discrete hardware component, a dedicated hardware finite state machine, any other suitable entity that can at least one of manipulate information (e.g., calculating, logical operations, and the like) and control another device, or a combination thereof. The processing system can also include a non-transitory machine-readable media (e.g., the memory 310) that stores software. Software can mean any type of instructions, whether referred to as at least one of software, firmware, middleware, microcode, hardware description language, and the like. Instructions can include code (e.g., in source code format, binary code format, executable code format, or any other suitable code format). The instructions, when executed by the processor 305, can transform the processor 305 into a special-purpose processor that is configured to perform at least a part of a function described herein.

The VLC AP 300 can also include a housing 315. The components of the VLC AP 300 can be coupled together by a bus system 320. The bus system 320 can include a data bus, a power bus, a control signal bus, a status signal bus, or a combination thereof. The components of the VLC AP 300 can be coupled together to accept and/or provide inputs to each other using a different suitable mechanism.

The VLC AP 300 can also comprise a user interface 325. The user interface 325 can comprise a keypad, a touchscreen, a microphone, a speaker, a display, or a combination thereof. The user interface 325 can include a component that at least one of conveys information to a user of the VLC AP 300 and receives input from the user.

The VLC AP 300 includes a VLC transmitter 330. The VLC transmitter 330 can include an encoder and modulator 335 that is configured to receive data from the bus system 320. For example, the data can be an identifier (e.g., a media access control (MAC) address) that uniquely identifies a geographic location (e.g., a room in a building, a venue, and the like). Based on these inputs, the encoder and modulator 335 can generate a transmission that is sent to a luminary device 340 (e.g., an LED) to be communicated using VLC. The encoder and modulator 335 can implement any practicable modulation scheme in generating the transmission, such as amplitude modulation (AM), Pulse Width Modulation (PWM), Frequency Shift Keying (FSK), and the like. The luminary device 340 then illuminates according to the transmission, converting the transmission to visible light 345 (e.g., the visible light 106) that can be received by a mobile device (e.g., the mobile device 200).

FIG. 4 depicts the exemplary RF wireless access point (AP) 400. The RF wireless AP 400 can correspond to the RF wireless AP 108. The RF wireless AP 400 is capable of receiving and/or transmitting using a radio frequency signal. The communication network 100 can support any practicable number of the RF wireless AP 400 distributed in a geographic region to provide communication coverage for at least one mobile device. For simplicity, only one RF wireless AP is depicted in FIG. 4, providing coordination and control among one or more mobile devices. The RF wireless AP 400 can be a fixed entity that provides backhaul services to the at least one mobile device in the RF wireless AP's 400 geographic region of coverage. However, the RF wireless AP 400 can be mobile in some applications (e.g., a mobile device serving as a wireless hotspot for other devices).

As depicted in the example of FIG. 4, the RF wireless access point 400 can include a transmit (TX) data processor 405, a symbol modulator 410, a transmitter 415, an antenna 420, a receiver 425, a symbol demodulator 430, a receive (RX) data processor 435, and a configuration information processor 440, each performing an operation associated with communicating with one or more user devices 445. The user device 445 can correspond to the mobile device 104. The RF wireless AP 400 can also include a controller 450 and a memory 455 configured to process and/or store data and/or instructions. Together, via a bus system 460, these components can perform special-purpose processing, as well as other functions for the RF wireless AP 400.

The controller 450 is configured to control operation of the access point 400. The controller 450 can be a central processing unit (CPU) and/or a special-purpose processor. The memory 455, which can include at least one of read-only memory (ROM) and random access memory (RAM) provides at least one of instructions and data to the controller 450. The controller 450 can perform logical and arithmetic operations based on processor-executable instructions stored within the memory 455. The instructions in the memory 455 can be executable to implement at least a part of a method described herein.

The controller 450 can comprise or be a component of a processing system implemented with one or more processors. The one or more processors can be implemented with a microprocessor, a microcontroller, a digital signal processor (DSP), a field programmable gate array (FPGA), a programmable logic device (PLD), an application-specific integrated circuit (ASIC), a controller, a non-generic computer, a state machine, gated logic, at least one discrete hardware component, a dedicated hardware finite state machine, any other suitable entity that can at least one of manipulate information (e.g., calculating, logical operations, and the like) and control another device, or a combination thereof. The processing system can also include a non-transitory machine-readable media (e.g., the memory 455) that stores software. Software can mean any type of instructions, whether referred to as at least one of software, firmware, middleware, microcode, hardware description language, and the like. Instructions can include code (e.g., in source code format, binary code format, executable code format, or any other suitable code format). The instructions, when executed by the controller 450, can transform the controller 450 into a special-purpose processor that causes the processor to perform at least a part of a function described herein.

The RF wireless AP 400 can also include an interface 465 that is configured to couple at least one of the constituent components of the RF wireless AP 400 to the backhaul connection 112. Thus, the RF wireless AP 400 can communicate with other APs and/or other networks (e.g., at least one of the Internet, a cellular network, a private network, and the like) via the backhaul connection 112.

The components of the RF wireless AP 400 can be coupled together by the bus system 460. The bus system 460 can include at least one of a data bus, a power bus, a control signal bus, and a status signal bus. The components of the RF wireless AP 400 can be coupled together to accept and/or provide inputs to each other using a different suitable mechanism.

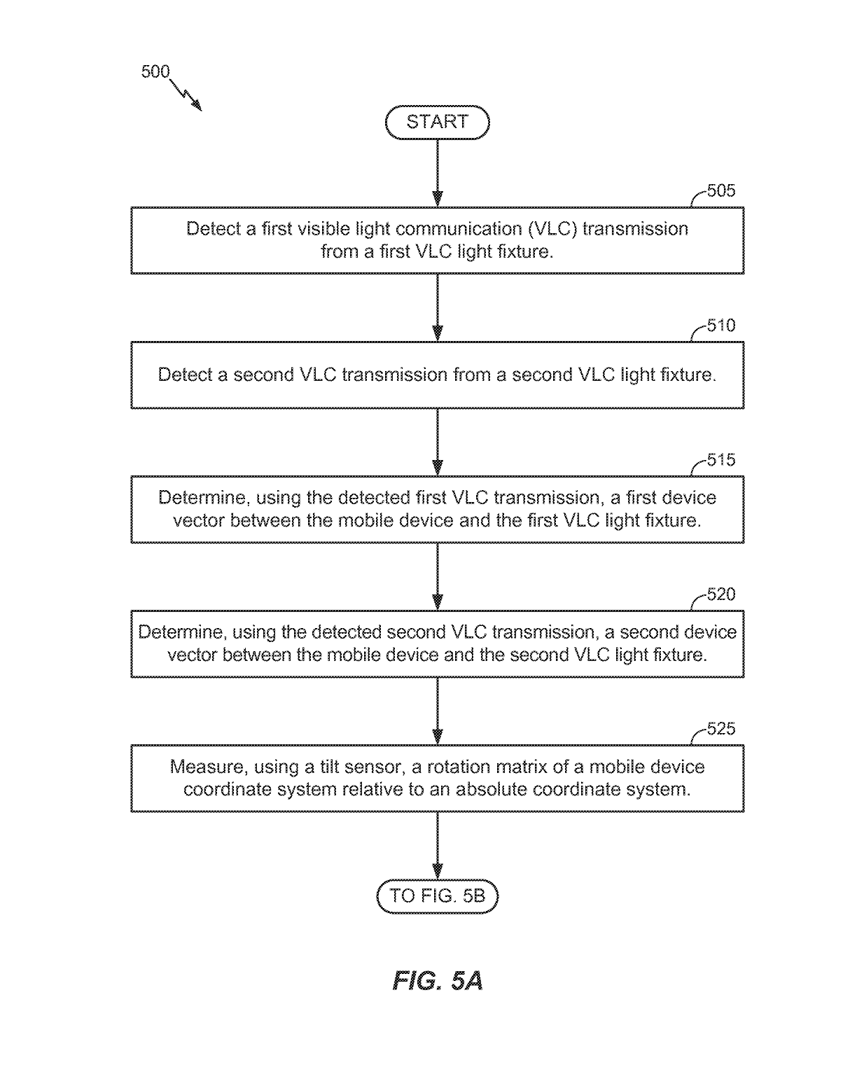

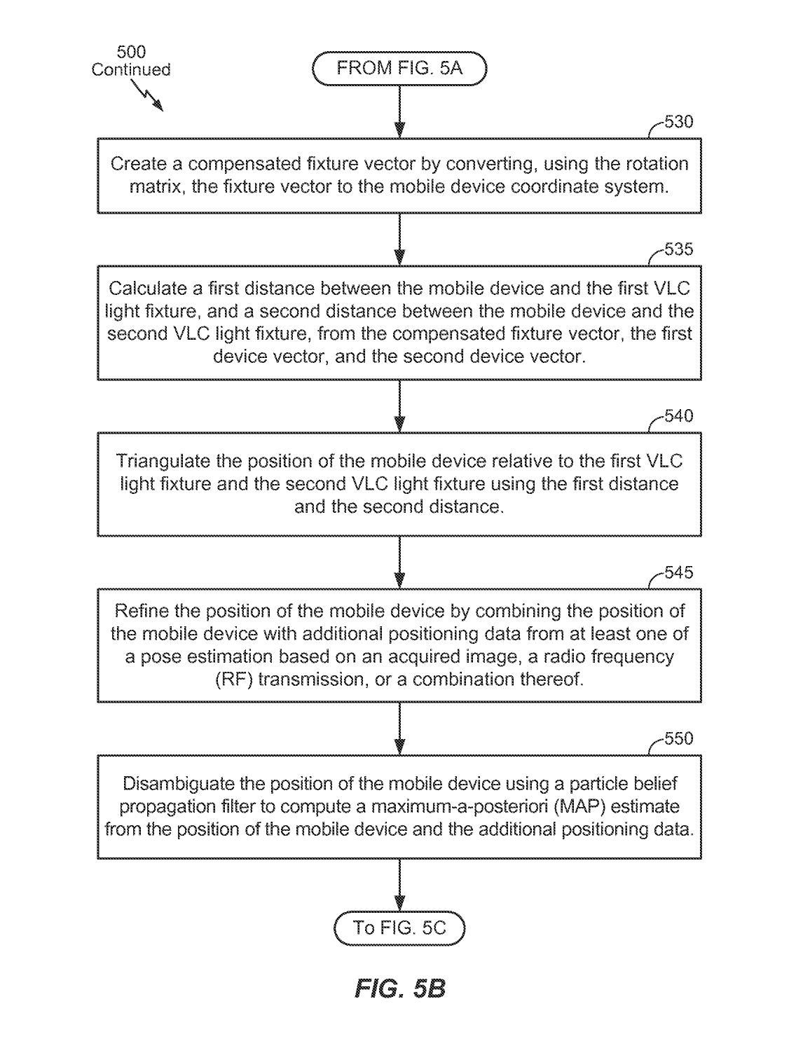

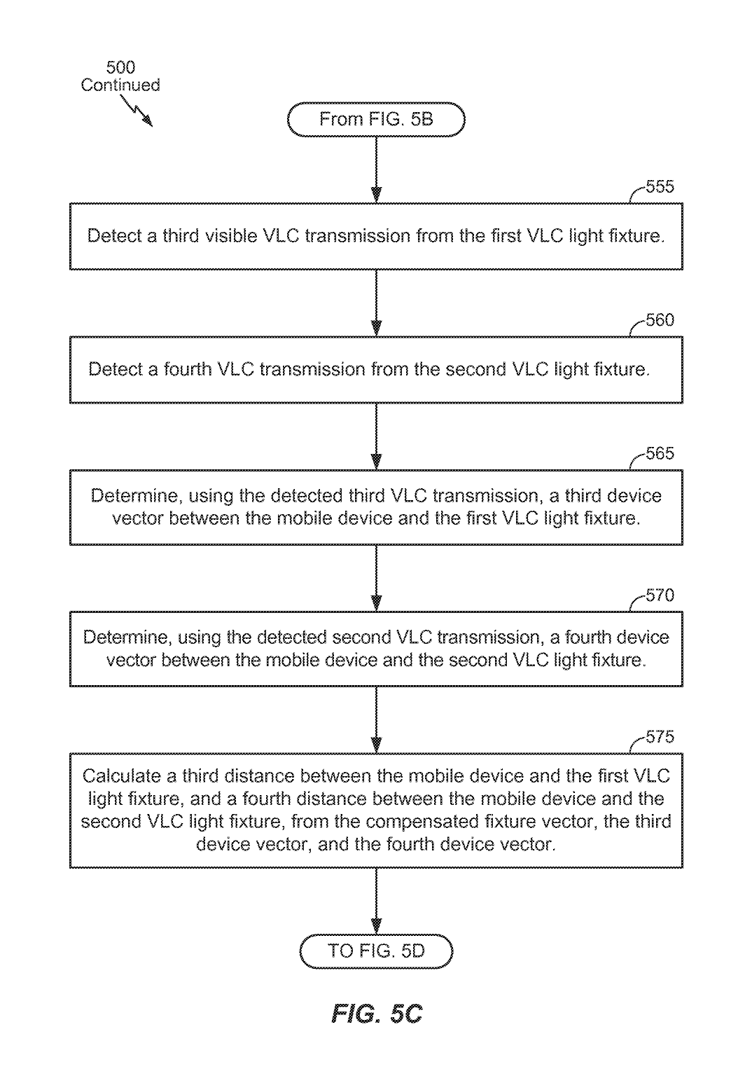

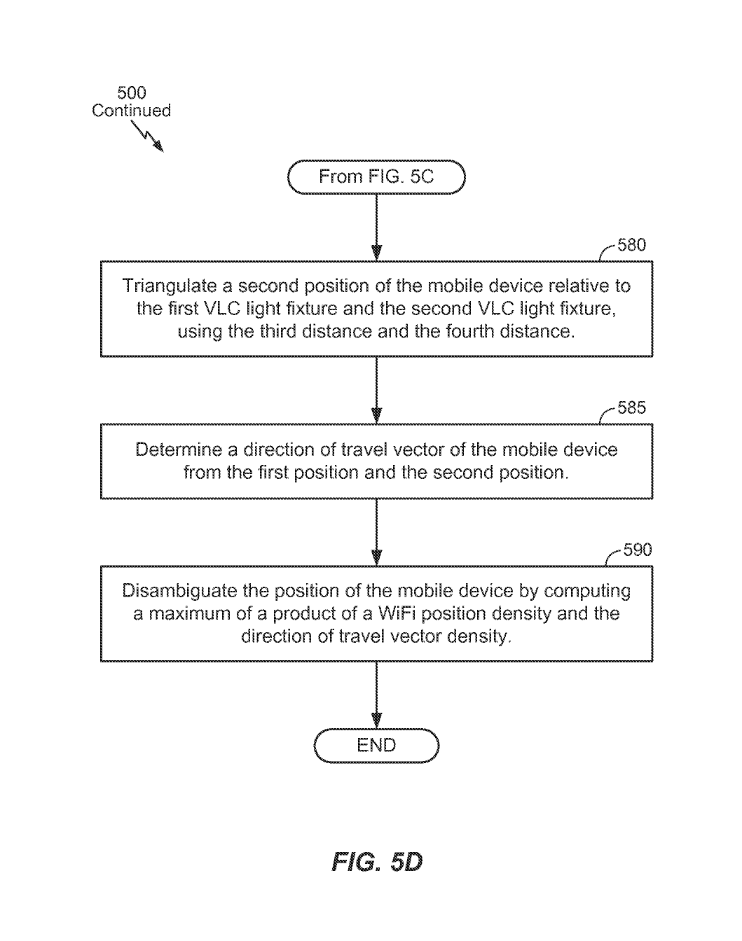

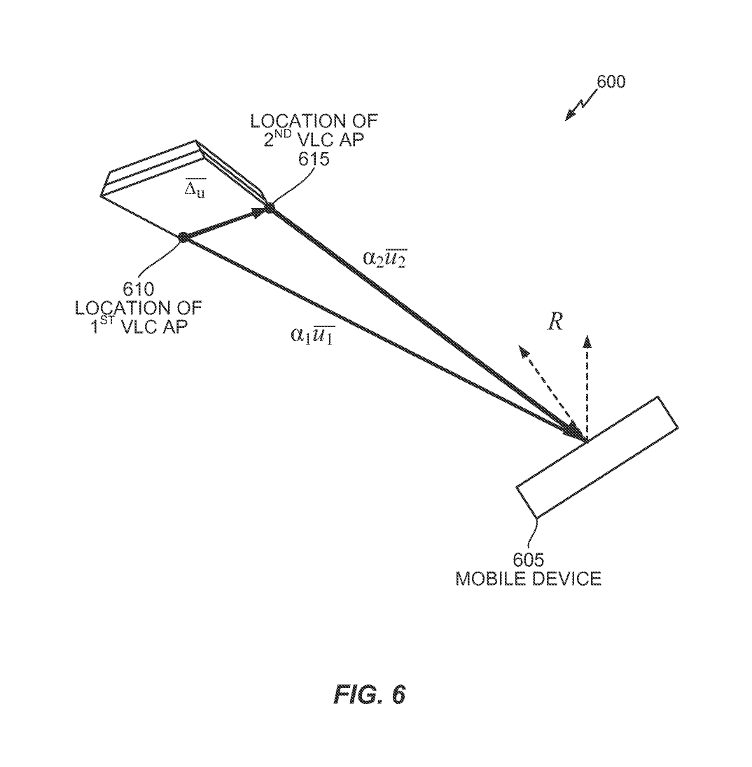

FIGS. 5A-5D depict an exemplary method for determining a position of a mobile device 500. The method for determining a position of a mobile device 500 can be performed by the apparatus described hereby, such as at least one of the mobile device 200, the VLC AP 300, and/or the RF wireless AP 400. Please also refer to FIG. 6, which depicts a version of the method for determining a position of a mobile device 500 in graphical form.

In block 505, a first VLC transmission from a first VLC light fixture is detected.

In block 510, a second VLC transmission from a second VLC light fixture is detected. A fixture vector between the first VLC light fixture and the second VLC light fixture is known, or can be determined from VLC AP location data that is stored by a mobile station, retrieved by the mobile station, or a combination thereof.

In block 515, using the detected first VLC transmission, a first device vector between the mobile device and the first VLC light fixture is determined.

In block 520, using the detected second VLC transmission, a second device vector between the mobile device and the second VLC light fixture is determined.

In block 525, using a tilt sensor, a rotation matrix of a mobile device coordinate system is measured relative to an absolute coordinate system. The absolute coordinate system can be based on at least one of an absolute gravity vector, a building envelope, a geomagnetic orientation, or a combination thereof.

In block 530, a compensated fixture vector is created by converting, using the rotation matrix, the fixture vector to the mobile device coordinate system.

In block 535, a first distance between the mobile device and the first VLC light fixture is calculated, and a second distance between the mobile device and the second VLC light fixture is calculated, from the compensated fixture vector, the first device vector, and the second device vector.

In block 540, the position of the mobile device is triangulated relative to the first VLC light fixture and the second VLC light fixture using the first distance and the second distance.

Blocks 545 through 590 are optional.

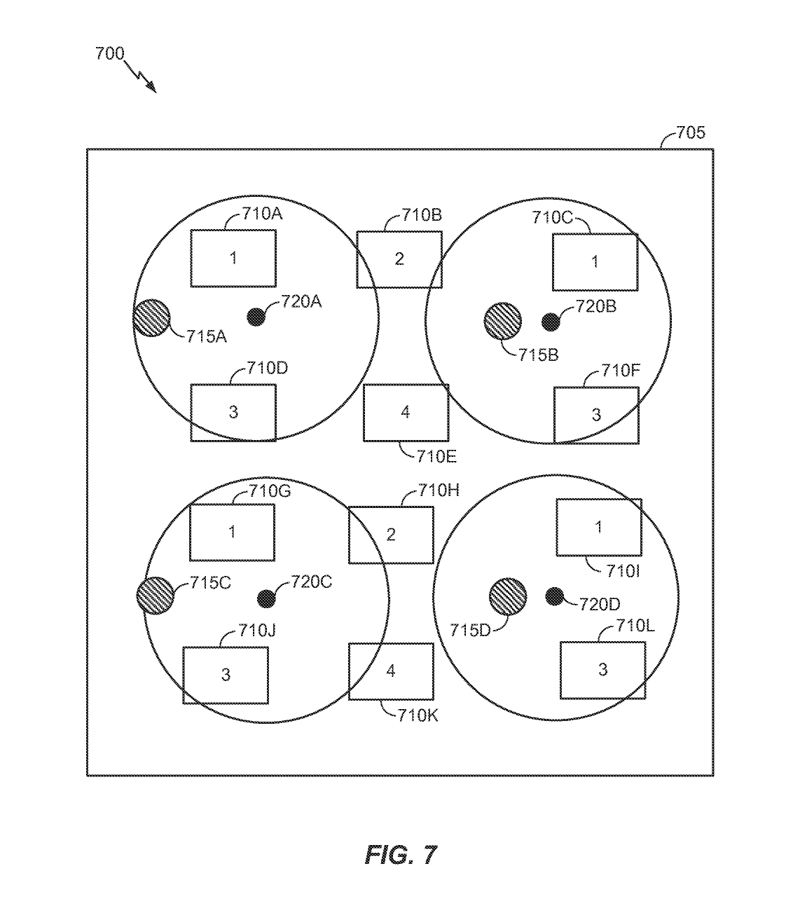

In block 545, the position of the mobile device can be refined and/or disambiguated by combining the position of the mobile device with additional positioning data from at least one of a pose estimation based on an acquired image, a radio frequency (RF) transmission, or a combination thereof. The RF transmission can be at least one of a Bluetooth device transmission, a WiFi device transmission, an RFID device transmission, a femtocell device transmission, a Zigbee device transmission, or a combination thereof. Please also refer to FIG. 7, which depicts further detail about refining and disambiguating the position of the mobile device by using a received RF transmission.

In block 550, the position of the mobile device can be disambiguated using a particle belief propagation filter to compute a maximum-a-posteriori (MAP) estimate from the position of the mobile device and the additional positioning data to determine where the mobile device is most likely to be located. Disambiguating in this manner can leverage output data from a precise indoor positioning (PIP) system. For example, the MAP estimate can be calculated using Equation One:

argmax_{ztεS}p(xₜ|r₁,r₂, . . . ,rₜ,v₁,v₂, . . . ,vₜ,ID₁,ID₂, . . . ,IDₜ)

### Where:

xₜ is a determined location of the mobile device at time t.
S is a set of locations (xₜ) of the mobile device at time t;
r₁, r₂, . . . , rₜ are WiFi received signal strength measurements (RSSI) rₜ at time t.
v₁, v₂, . . . , vₜ are Direction of Arrival (DoA) vectors (vₜ) to detected VLC APs at time t; and
ID₁, ID₂, . . . , IDₜ are identifiers IDₜ of the detected VLC APs at time t.

### Equation One

In an example, blocks 555 through 585 can be performed as a group.

In block 555, a third visible VLC transmission from the first VLC light fixture can be detected.

In block 560, a fourth VLC transmission from the second VLC light fixture can be detected.

In block 565, using the detected third VLC transmission, a third device vector between the mobile device and the first VLC light fixture can be determined.

In block 570, using the detected second VLC transmission, a fourth device vector between the mobile device and the second VLC light fixture can be determined.

In block 575, a third distance between the mobile device and the first VLC light fixture can be calculated, and a fourth distance between the mobile device and the second VLC light fixture can be calculated, from the compensated fixture vector, the third device vector, and the fourth device vector.

In block 580, a second position of the mobile device can be triangulated relative to the first VLC light fixture and the second VLC light fixture, using the third distance and the fourth distance.

In block 585, a direction of travel vector of the mobile device from the first position and the second position can be determined.

In block 590, the position of the mobile device can be disambiguated by computing a maximum of a product of a WiFi position density and the direction of travel vector density to determine where the mobile device is most likely to be located. This calculation uses the fact that VLC IDs are locally unique to remove a need for conditioning the data. For example, the maximum can be calculated using Equation Two:

argmax_{xtεS}p(xₜ|r₁,r₂, . . . ,rₜ)p(xₜ|vₜ,IDₜ)

### Where:

xₜ is a determined location of the mobile device at time t.
S is a set of locations (xₜ) of the mobile device at time t;
p(xₜ|r₁, r₂, . . . , rₜ) is probability of the mobile device being located at location xₜ based on a PIP system output indicating a range (rₜ) at time t; and
p(xₜ|vₜ, ID_{E}) is probability of the mobile device being located at location xₜ based on a VLC AP detector engine output indicating a vector (vₜ) to the VLC AP having identifier ID at time t.

### Equation Two

The functionality of the modules depicted in FIGS. 5A-5D can be implemented in ways consistent with the teachings herein. In some designs, the functionality of these modules can be implemented as one or more electrical components. In some designs, the functionality of these blocks can be implemented as a processing system including one or more processor components. In some designs, the functionality of these modules can be implemented using, for example, at least a portion of one or more integrated circuits (e.g., an application-specific integrated circuit (ASIC)). As discussed herein, an integrated circuit can include a processor, software, other related components, or some combination thereof. Thus, the functionality of different modules can be implemented, for example, as different subsets of an integrated circuit, as different subsets of a set of software modules, or a combination thereof. Also, it will be appreciated that a given subset (e.g., of an integrated circuit and/or of a set of software modules) can provide at least a portion of the functionality for more than one module.

In addition, the components and functions represented by FIGS. 5A-5D, as well as other components and functions described herein, can be implemented using any suitable means. Such means also can be implemented, at least in part, using corresponding structure as taught herein. For example, the components described above in conjunction with the “module for” components of FIGS. 5A-5D also can correspond to similarly designated “means for” functionality. Thus, in some aspects, one or more of such means can be implemented using one or more of processor components, integrated circuits, or other suitable structure as taught herein.

FIG. 6 depicts a graphical version 600 of the method for determining a position of a mobile device 500. In FIG. 6, the Direction of Arrival (DoA) of a mobile device 605 relative to a specific VLC AP is represented by a unit vector ū in the device coordinate system. A rotation matrix of the device's coordinate system around that of the absolute coordinate system (e.g., an earth-centric coordinate system) is represented by R, thus a conversion from data in the absolute coordinate system to data in the device coordinate system is represented by R⁻¹. A mobile device, such as the mobile device 200, determines a three-dimensional position and orientation relative to at least two VLC APs, such as a first VLC AP 610 and a second VLC AP 615, by detecting the at least two VLC APs. In an implementation, the first VLC AP 610 and the second VLC AP 615 can be the VLC AP 300, two fixtures, two ROIs, and/or the like. A fixture vector Δū connecting the two VLC APS is known. The mobile device then solves Equation Three for a distance to the first VLC AP 610 (α₁) and a distance to the second VLC AP 615 (α₂):

α₁ū₁+α₂ū₂=R⁻¹Δū Equation Three

Once the distance to the first VLC AP 610 (α₁) and the distance to the second VLC AP 615 (α₂) are known, then the position of the mobile device 605 can be determined by triangulating, relative to the known positions of the first VLC AP 610 and the second VLC AP 615.

The foregoing steps are not limiting of the examples. The steps can be combined and/or the order can be rearranged, as practicable.

FIG. 7 depicts further detail 700 about refining and disambiguating a position of a mobile device by using a received RD transmission. FIG. 7 depicts a venue 705 including twelve VLC APs 710A-710L. Each of the twelve VLC APs transmits a VLC AP identifier (#1-#4). As can be seen from FIG. 7, some of the VLC APs transmit the same identifier—this can cause gross errors in a position determined by the mobile device. Thus, if the mobile device determines candidate positions 715A-715D based on VLC APs transmitting identifiers of #1 and #3, the mobile device could be in any of four different locations. Disambiguating the mobile device's position by using an RF transmission entails receiving an RF transmission from a transmitter, such as a Bluetooth device transmission, a WiFi device transmission, an RFID device transmission, a femtocell device transmission, a Zigbee device transmission, or a combination thereof. In FIG. 7, locations of different exemplary RF transmitters 720A-720D are depicted as centered about a respective RF transmission coverage zone. To disambiguate the mobile device's location, the mobile device determines in which respective RF transmission coverage zone the mobile device is located from the RF transmission. The mobile device can decode data, such as an RF identifier and/or location data, which is transmitted by an RF transmitter. The mobile device can also look up a location of a specific RF transmitter in a local or remote database. Other methods can be sued to determine a location of a specific RF transmitter, such as by measuring RSSI of a received RF signal, measuring signal timing (e.g., a round-trip time), or other physical properties of a received RF signal.

Then, the mobile device can determine which of the candidate positions 715A-715D is the correct location of the mobile device by correlating the candidate positions 715A-715D to the respective RF transmission coverage zone within which the mobile device is located. For example, if the mobile device determines, using a VLC-based positioning technique, that the mobile device is located at one of the candidate positions 715A-715D, and the mobile device receives an RF transmission from RF transmitter 720A, then the mobile device can disambiguate and determine that the mobile device is located at candidate position 715A, and not at candidate positions 715B-715D.

In view of the descriptions and explanations above, those of skill in the art will appreciate that the various illustrative logical blocks, modules, circuits, and algorithm steps described in connection with the aspects disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present disclosure.

Exemplary aspects of the disclosure can include a computer-readable medium embodying a method for determining a position of a mobile device. An example can include a non-transitory (i.e., a non-transient) machine-readable media and/or a non-transitory (i.e., a non-transient) computer-readable media storing processor-executable instructions which, when executed by a processor (such as a special-purpose processor), transform the processor and any other cooperating devices into a machine (e.g., a special-purpose processor) configured to perform at least a part of a function described herein. In an example, executing the stored instructions can transform a processor and any other cooperating devices into at least a part of an apparatus described herein. A non-transitory (i.e., a non-transient) machine-readable media specifically excludes a transitory propagating signal.

An apparatus or any component of an apparatus can be configured to (or made operable to or adapted to) provide functionality as taught herein. This can be achieved, for example: by manufacturing (e.g., fabricating) the apparatus or component so that it will provide the functionality, by programming the apparatus or component so that it will provide the functionality, or through the use of some other suitable implementation technique. As one example, an integrated circuit can be fabricated to provide the requisite functionality. As another example, an integrated circuit can be fabricated to support the requisite functionality and then configured (e.g., via programming) to provide the requisite functionality. As yet another example, a processor circuit can execute code to provide the requisite functionality.

Moreover, the methods, sequences, and algorithms described in connection with the aspects disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium can be integral to the processor (e.g., cache memory).

This disclosure is not intended to be limited to any specific example. For example, unless otherwise noted, the functions, steps, and/or actions of the method claims in accordance with the aspects of the disclosure described herein need not be performed in any particular order. Furthermore, although certain aspects can be described or claimed in the singular, the plural is contemplated unless limitation to the singular is explicitly stated.

Nothing stated or illustrated depicted in this application is intended to dedicate any component, step, feature, object, benefit, advantage, or equivalent to the public, regardless of whether the component, step, feature, object, benefit, advantage, or the equivalent is recited in the claims. Changes and modifications can be made to the examples without departing from the scope defined by the claims.

What is claimed is:

1. A method for determining a position of a mobile device, the method comprising:
detecting a first visible light communication (VLC) transmission from a first VLC light fixture;
detecting a second VLC transmission from a second VLC light fixture, where a fixture vector between the first VLC light fixture and the second VLC light fixture is known;
determining, using the detected first VLC transmission, a first device vector between the mobile device and the first VLC light fixture;
determining, using the detected second VLC transmission, a second device vector between the mobile device and the second VLC light fixture;
measuring, using a tilt sensor, a rotation matrix of a mobile device coordinate system relative to an absolute coordinate system;
creating a compensated fixture vector by converting, using the rotation matrix, the fixture vector to the mobile device coordinate system;
calculating a first distance between the mobile device and the first VLC light fixture, and a second distance between the mobile device and the second VLC light fixture, from the compensated fixture vector, the first device vector, and the second device vector; and
triangulating the position of the mobile device relative to the first VLC light fixture and the second VLC light fixture using the first distance and the second distance.

2. The method of claim 1, further comprising:
refining the position of the mobile device by combining the position of the mobile device with additional positioning data from at least one of the following:
a pose estimation based on an acquired image;
a radio frequency (RF) transmission; or
a combination thereof.

3. The method of claim 2, further comprising disambiguating the position of the mobile device using a particle belief propagation filter to compute a maximum-a-posteriori (MAP) estimate from the position of the mobile device and the additional positioning data.

4. The method of claim 2, wherein the RF transmission is at least one of a Bluetooth device transmission, a WiFi device transmission, an RFID device transmission, a femtocell device transmission, a Zigbee device transmission, or a combination thereof.

5. The method of claim 1, wherein the absolute coordinate system is based on at least one of an absolute gravity vector, a building envelope, a geomagnetic orientation, or a combination thereof.

6. The method of claim 1, further comprising:
detecting a third visible VLC transmission from the first VLC light fixture;
detecting a fourth VLC transmission from the second VLC light fixture;
determining, using the detected third VLC transmission, a third device vector between the mobile device and the first VLC light fixture;
determining, using the detected second VLC transmission, a fourth device vector between the mobile device and the second VLC light fixture;
calculating a third distance between the mobile device and the first VLC light fixture, and a fourth distance between the mobile device and the second VLC light fixture, from the compensated fixture vector, the third device vector, and the fourth device vector;
triangulating a second position of the mobile device relative to the first VLC light fixture and the second VLC light fixture using the third distance and the fourth distance; and
determining a direction of travel vector of the mobile device from the first position and the second position.

7. The method of claim 6, further comprising disambiguating the position of the mobile device by computing a maximum of a product of a WiFi position density and a direction of travel vector density of the direction of travel vector of the mobile device.

8. An apparatus configured to determine a position of a mobile device, comprising:
means for detecting a first visible light communication (VLC) transmission from a first VLC light fixture;
means for detecting a second VLC transmission from a second VLC light fixture, where a fixture vector between the first VLC light fixture and the second VLC light fixture is known;
means for determining, using the detected first VLC transmission, a first device vector between the mobile device and the first VLC light fixture;
means for determining, using the detected second VLC transmission, a second device vector between the mobile device and the second VLC light fixture;
means for measuring, using a tilt sensor, a rotation matrix of a mobile device coordinate system relative to an absolute coordinate system;
means for creating a compensated fixture vector by converting, using the rotation matrix, the fixture vector to the mobile device coordinate system;
means for calculating a first distance between the mobile device and the first VLC light fixture, and a second distance between the mobile device and the second VLC light fixture, from the compensated fixture vector, the first device vector, and the second device vector; and
means for triangulating the position of the mobile device relative to the first VLC light fixture and the second VLC light fixture using the first distance and the second distance.

9. The apparatus of claim 8, further comprising means for refining the position of the mobile device by combining the position of the mobile device with additional positioning data from at least one of the following:
a pose estimation based on an acquired image;
a radio frequency (RF) transmission; or
a combination thereof.

10. The apparatus of claim 9, further comprising means for disambiguating the position of the mobile device using a particle belief propagation filter to compute a maximum-a-posteriori (MAP) estimate from the position of the mobile device and the additional positioning data.

11. The apparatus of claim 9, wherein the RF transmission is at least one of a Bluetooth device transmission, a WiFi device transmission, an RFID device transmission, a femtocell device transmission, a Zigbee device transmission, or a combination thereof.

12. The apparatus of claim 8, wherein the absolute coordinate system is based on at least one of an absolute gravity vector, a building envelope, a geomagnetic orientation, or a combination thereof.

13. The apparatus of claim 8, further comprising:
means for detecting a third visible VLC transmission from the first VLC light fixture;
means for detecting a fourth VLC transmission from the second VLC light fixture; determining, using the detected third VLC transmission, a third device vector between the mobile device and the first VLC light fixture;
means for determining, using the detected second VLC transmission, a fourth device vector between the mobile device and the second VLC light fixture;
means for calculating a third distance between the mobile device and the first VLC light fixture, and a fourth distance between the mobile device and the second VLC light fixture, from the compensated fixture vector, the third device vector, and the fourth device vector;
means for triangulating a second position of the mobile device relative to the first VLC light fixture and the second VLC light fixture using the third distance and the fourth distance; and
means for determining a direction of travel vector of the mobile device from the first position and the second position.

14. The apparatus of claim 13, further comprising means for disambiguating the position of the mobile device by computing a maximum of a product of a WiFi position density and a direction of travel vector density of the direction of travel vector of the mobile device.

15. The apparatus of claim 8, wherein the apparatus is a part of the mobile device.

16. A mobile device, comprising:
a communication device; and
a processor coupled to the communication device and configured to:
initiate detecting a first visible light communication (VLC) transmission from a first VLC light fixture;
initiate detecting a second VLC transmission from a second VLC light fixture, where a fixture vector between the first VLC light fixture and the second VLC light fixture is known;
initiate determining, using the detected first VLC transmission, a first device vector between the mobile device and the first VLC light fixture;
initiate determining, using the detected second VLC transmission, a second device vector between the mobile device and the second VLC light fixture;
initiate measuring, using a tilt sensor, a rotation matrix of a mobile device coordinate system relative to an absolute coordinate system;
initiate creating a compensated fixture vector by converting, using the rotation matrix, the fixture vector to the mobile device coordinate system;
initiate calculating a first distance between the mobile device and the first VLC light fixture, and a second distance between the mobile device and the second VLC light fixture, from the compensated fixture vector, the first device vector, and the second device vector; and
initiate triangulating a position of the mobile device relative to the first VLC light fixture and the second VLC light fixture using the first distance and the second distance.

17. The mobile device of claim 16, wherein the processor is further configured to refine the position of the mobile device by combining the position of the mobile device with additional positioning data from at least one of the following:
a pose estimation based on an acquired image;
a radio frequency (RF) transmission; or
a combination thereof.

18. The mobile device of claim 17, wherein the processor is further configured to disambiguate the position of the mobile device using a particle belief propagation filter to compute a maximum-a-posteriori (MAP) estimate from the position of the mobile device and the additional positioning data.

19. The mobile device of claim 17, wherein the RF transmission is at least one of a Bluetooth device transmission, a WiFi device transmission, an RFID device transmission, a femtocell device transmission, a Zigbee device transmission, or a combination thereof.

20. The mobile device of claim 16, wherein the absolute coordinate system is based on at least one of an absolute gravity vector, a building envelope, a geomagnetic orientation, or a combination thereof.

21. The mobile device of claim 16, wherein the processor is further configured to:
detect a third visible VLC transmission from the first VLC light fixture;
detect a fourth VLC transmission from the second VLC light fixture;
determine, using the detected third VLC transmission, a third device vector between the mobile device and the first VLC light fixture;
determine, using the detected second VLC transmission, a fourth device vector between the mobile device and the second VLC light fixture;
calculate a third distance between the mobile device and the first VLC light fixture, and a fourth distance between the mobile device and the second VLC light fixture, from the compensated fixture vector, the third device vector, and the fourth device vector;
triangulate a second position of the mobile device relative to the first VLC light fixture and the second VLC light fixture using the third distance and the fourth distance; and
determine a direction of travel vector of the mobile device from the first position and the second position.

22. The mobile device of claim 21, wherein the processor is further configured to disambiguate the position of the mobile device by computing a maximum of a product of a WiFi position density and a direction of travel vector density of the direction of travel vector of the mobile device.

23. An article for determining a position of a mobile device, the article comprising:
a non-transitory computer-readable medium having processor-executable instructions stored thereon that are executable by a processor to:
initiate detecting a first visible light communication (VLC) transmission from a first VLC light fixture;
initiate detecting a second VLC transmission from a second VLC light fixture, where a fixture vector between the first VLC light fixture and the second VLC light fixture is known;
initiate determining, using the detected first VLC transmission, a first device vector between the mobile device and the first VLC light fixture;
initiate determining, using the detected second VLC transmission, a second device vector between the mobile device and the second VLC light fixture;
initiate measuring, using a tilt sensor, a rotation matrix of a mobile device coordinate system relative to an absolute coordinate system;
initiate creating a compensated fixture vector by converting, using the rotation matrix, the fixture vector to the mobile device coordinate system;
initiate calculating a first distance between the mobile device and the first VLC light fixture, and a second distance between the mobile device and the second VLC light fixture, from the compensated fixture vector, the first device vector, and the second device vector; and
initiate triangulating the position of the mobile device relative to the first VLC light fixture and the second VLC light fixture using the first distance and the second distance.

24. The article of claim 23, wherein the processor-executable instructions are further executable by the processor to:
initiate refining the position of the mobile device by combining the position of the mobile device with additional positioning data from at least one of the following:
a pose estimation based on an acquired image;
a radio frequency (RF) transmission; or
a combination thereof.

25. The article of claim 24, wherein the processor-executable instructions are further executable by the processor to initiate disambiguating the position of the mobile device using a particle belief propagation filter to compute a maximum-a-posteriori (MAP) estimate from the position of the mobile device and the additional positioning data.

26. The article of claim 24, wherein the RF transmission is at least one of a Bluetooth device transmission, a WiFi device transmission, an RFID device transmission, a femtocell device transmission, a Zigbee device transmission, or a combination thereof.

27. The article of claim 23, wherein the absolute coordinate system is based on at least one of an absolute gravity vector, a building envelope, a geomagnetic orientation, or a combination thereof.

28. The article of claim 23, wherein the processor-executable instructions are further executable by the processor to:
initiate detecting a third visible VLC transmission from the first VLC light fixture;
initiate detecting a fourth VLC transmission from the second VLC light fixture;
initiate determining, using the detected third VLC transmission, a third device vector between the mobile device and the first VLC light fixture;
initiate determining, using the detected second VLC transmission, a fourth device vector between the mobile device and the second VLC light fixture;
initiate calculating a third distance between the mobile device and the first VLC light fixture, and a fourth distance between the mobile device and the second VLC light fixture, from the compensated fixture vector, the third device vector, and the fourth device vector;
initiate triangulating a second position of the mobile device relative to the first VLC light fixture and the second VLC light fixture using the third distance and the fourth distance; and
initiate determining a direction of travel vector of the mobile device from the first position and the second position.

29. The article of claim 28, wherein the processor-executable instructions are further executable by the processor to initiate disambiguating the position of the mobile device by computing a maximum of a product of a WiFi position density and a direction of travel vector density of the direction of travel vector of the mobile device.
